(19) United States
(12) Patent Application Publication
(10) Pub. No.: US 2006/0119932 A1
(43) Pub. Date: Jun. 8, 2006

(54) Manufacture of shaped structures in lcd cells, and masks therefor

(75) Inventors: Sungi-il Park, Daegu City (GB); Ian D French, Hove (GB)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., EINDHOVEN (NL)

(21) Appl. No.: 10/537,951

(22) PCT Filed: Nov. 28, 2003
(86) PCT No.: PCT/IB03/05705

§ 371 Date: Jun. 8, 2005

(30) Foreign Application Priority Data
Dec. 14, 2002 (GB) 0229228.2
Jan. 7, 2003 (GB) 0300360.5

(51) Int. Cl. G06K 7/10

(52) U.S. Cl. 359/350

(57) ABSTRACT

A method of forming shaped structures in liquid crystal display cells, comprises applying a photosensitive layer (6) to a transistor plate (2), and forming the shaped structures on the photosensitive layer in a photolithographic process using a grey-tone photo mask (7, 21). This mask comprises at least one region of semi-transparent material (8, 16, 18), the degree of transparency of which is dependent on the optical band gap of the material.

The invention relates to the manufacture of liquid crystal displays, and features thereof. In particular, the invention relates to a method for forming shaped structures in liquid crystal display (LCD) cells using semi-transparent masks.

One such example of a shaped structure in a LCD is the diffusely reflective pixel electrode as used in a thin film transistor (TFT) reflective active matrix liquid crystal display (reflective AMLCD). This is generally formed with an irregular upper surface topography, so that when coated with a reflective metal layer, usually aluminium or silver, incident light is dispersed over the viewing area of the LCD. It is important that the dispersion is controlled to achieve a compromise between having a suitably large viewing area and having an adequate brightness of reflected light in the viewing area. One known method for forming this irregular surface is to firstly apply a photosensitive layer to the TFT plate of the AMLCD. This layer is then patterned by conventional photolithography and etching, to create many micro-bumps on the surface of each pixel electrode of the TFT plate. This results in a surface topography with steeply sided islands, which is then heated so that reflow occurs, providing a more curved surface topography which can then be covered with the reflective metal coating.

In a more complex method of forming the diffusely reflective pixel electrode, such as that disclosed in U.S. Pat. No. 6,163,405, at least one slant is introduced to the surface of the pixel electrodes on the TFT plate before the forming of the micro bumps. In this manner, the light can be reflected into a preferred viewing area, which may not be perpendicular to the TFT plate. This type of slanted diffusive reflector is referred to as a diffusive micro slant reflector (DMSR).

U.S. Pat. No. 6,163,405 discloses several methods involving photolithography for forming such a slanted surface on a pixel electrode, and forming irregular micro bumps on this. The main method disclosed involves producing irregular ridges of different heights by using a single photo mask a number of times as part of a multi-exposure shift method of photolithography. The photo mask is arranged with small UV-transparent slots on an otherwise UV-opaque mask. UV-light is then directed through the mask and onto a layer of photosensitive material that has been coated onto the pixel electrodes. In positive photolithography, the UV light is used to expose the photosensitive material, and the exposed areas are removed during a developing stage. Conversely, negative photolithography involves removing, during a developing stage, areas of a photosensitive material that were not exposed to UV-light.

After UV exposure at a certain UV intensity, the mask with transparent slots is shifted a small amount and a further exposure step is performed, with a different UV intensity or exposure time. This can be carried out a number of times so that once developed, the pixel electrode surface is left with an irregularly stepped line of ridges on its surface topography. A further mask is then used to create the micro-bumps on the surface of the ridges, which are then heated to propagate reflow. This produces a DMSR pixel electrode with an optimised viewing area. However, in the production of LCD displays, the multiple UV exposures are very time consuming and costly. Furthermore, the standard photolithographic aligners used in AMLCD factories do not usually have the facility for multi-exposure shift. Accordingly, this particular multi-exposure method disclosed in U.S. Pat. No. 6,163,405 is impractical for use in large-scale production of LCD displays.

A further method disclosed in U.S. Pat. No. 6,163,405 uses a grey-tone mask, also known as a half-tone mask. This is a photo mask that has areas that exhibit at least one degree of semi-transparency to light. The result is that a certain intensity of UV-light for a set exposure time can be applied through this mask to produce multiple levels of exposure of a photosensitive material. For instance, a substrate for a LCD, coated with photosensitive material and exposed in a single UV exposure through a grey-tone mask, once developed, could have the same multi-level surface topography as that created using the multi-exposure shift method of photolithography.

One method for the production of grey-tone photo masks involves creating a fine pattern of transparent apertures on an otherwise opaque mask, which partially reduces the amount of UV-light penetration. Furthermore, the light that penetrates the mask is diffracted and hence dispersed, so that, when used to expose a photosensitive material, relatively uniform exposure is achieved. By altering the size of the apertures, different percentages of UV-light can be allowed to penetrate the mask. These types of grey-tone mask can be produced with almost any arbitrary feature shape. However, their major shortfall is that, where a very small feature size is required, less than 2 μm for instance such as in the production of diffusely reflective pixel electrodes for LCD's, they are very expensive to produce. Furthermore, diffraction at the edges of features on the mask causes the features to lack definition, and so the accuracy of the mask is limited. These shortfalls render the use of the diffraction mask impractical for certain applications in industry.

The invention proposes a method that decreases the cost associated with the production of shaped structures in AMLCD cells by using a grey-tone photo mask with a material such as hydrogenated silicon-rich silicon nitride in the photolithographic production process. Silicon-rich silicon nitride (SiNx) masks are relatively cheap to produce, even when small feature size is required.

According to one aspect of the invention there is provided a method of forming shaped structures on a device plate (e.g. a transistor plate), comprising applying a photosensitive layer to said plate, and forming the shaped structures on the photosensitive layer in a photolithographic process using a grey-tone photo mask, wherein the mask comprises at least one region of semi-transparent material, and said material has a degree of transparency which is dependent on the optical band gap of the material.

The invention further provides a method using such a photo mask in said photolithographic process so as to produce an irregular surface topography for a diffusely reflective pixel electrode of said liquid crystal display. Said surface topography for said diffusely reflective pixel electrode of the liquid crystal display may have multiple levels of thickness.

The material regions used in the grey-tone photo mask may be hydrogenated silicon-rich silicon nitride SiNx:H with x less than 1.

Advantageous features in accordance with the present invention are set out in the appended claims. These and others will be illustrated in specific embodiments of the invention now to be described, by way of example, with reference to the accompanying drawings, in which:

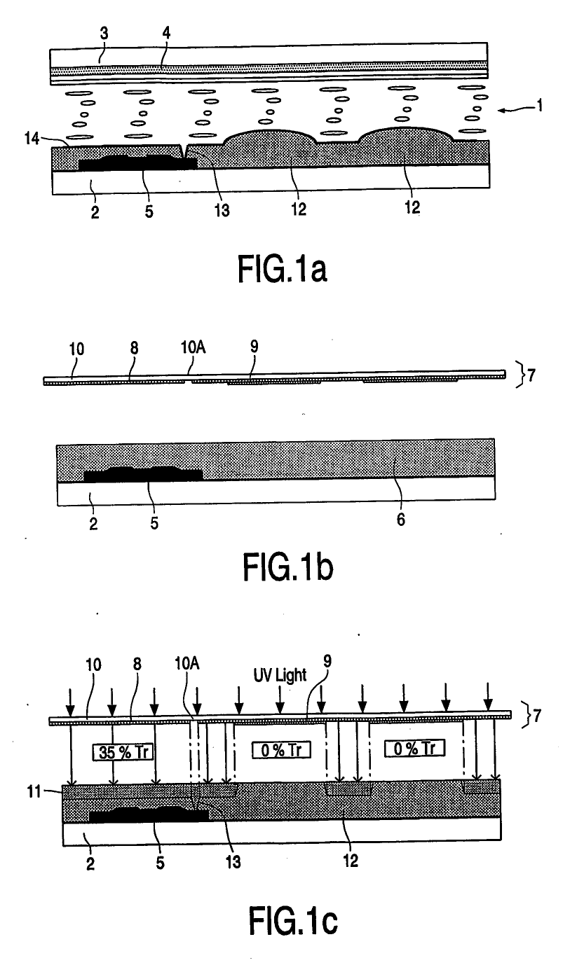

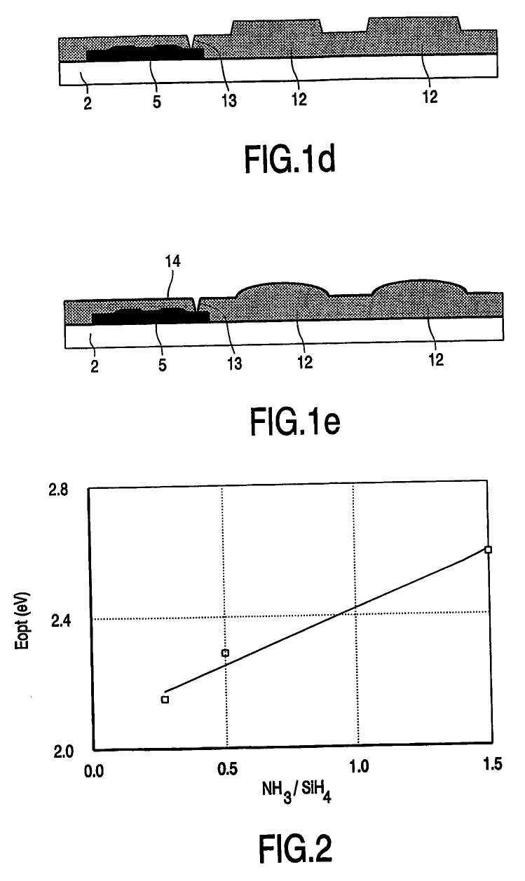

FIGS. 1a to 1e are cross-sectional views of a TFT plate for a reflective LCD display during various stages in the process used to define its diffusely reflective surface topography;

FIG. 2 is a graph on which is plotted the optical band gap of SiNx layers according to different NH3/SiH4 gas ratios as used in their production;

FIG. 3 is a graph plotting the transmission characteristics, according to the wavelength of light used, of three different formations of SiNx, A, B and C, each with a different optical band gap, as used in a photomask;

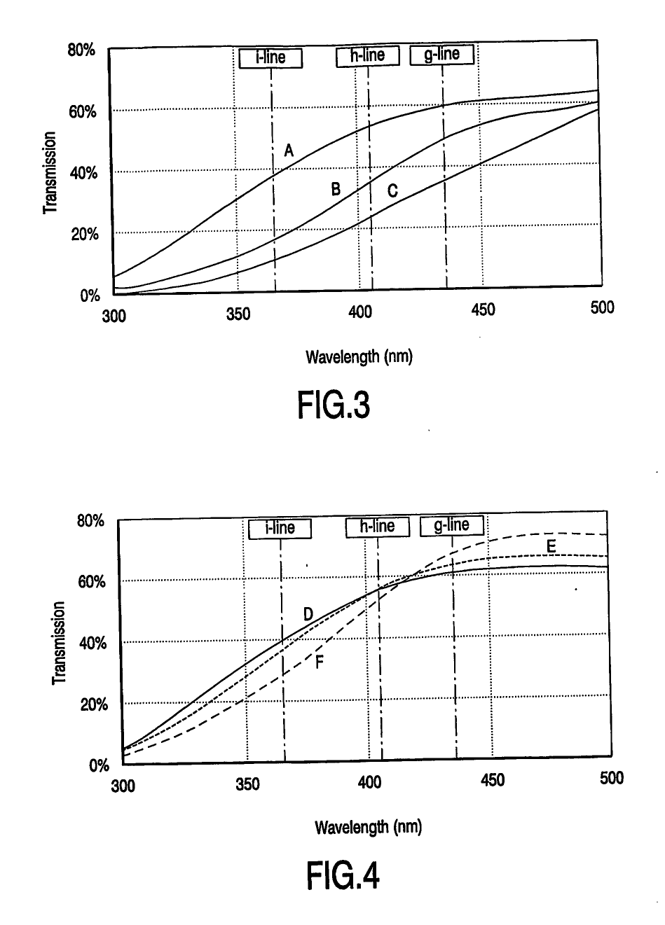

FIG. 4 is a graph on which is plotted the transmission percentage according to wavelength of light used, for three thicknesses of SiNx, D, E and F, each having an optical band gap of 2.3 eV;

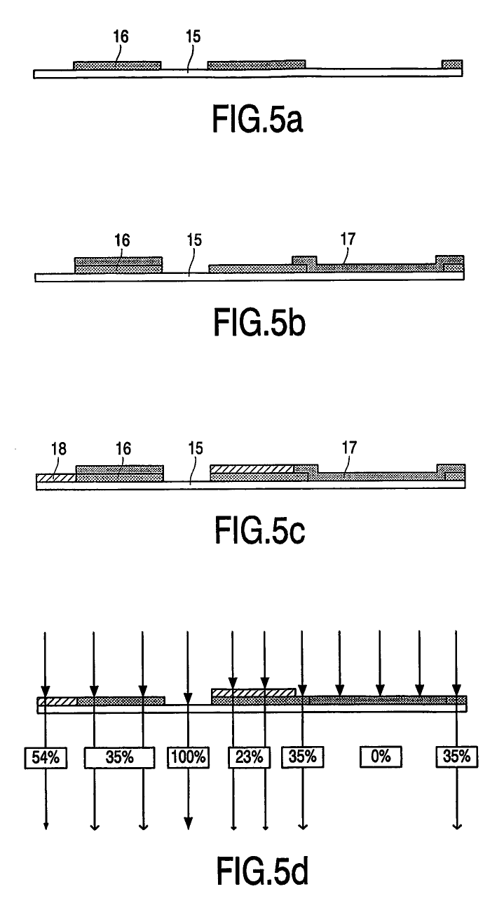

FIGS. 5a to 5d are cross-sectional views of a SiNx photo mask during various stages of its fabrication;

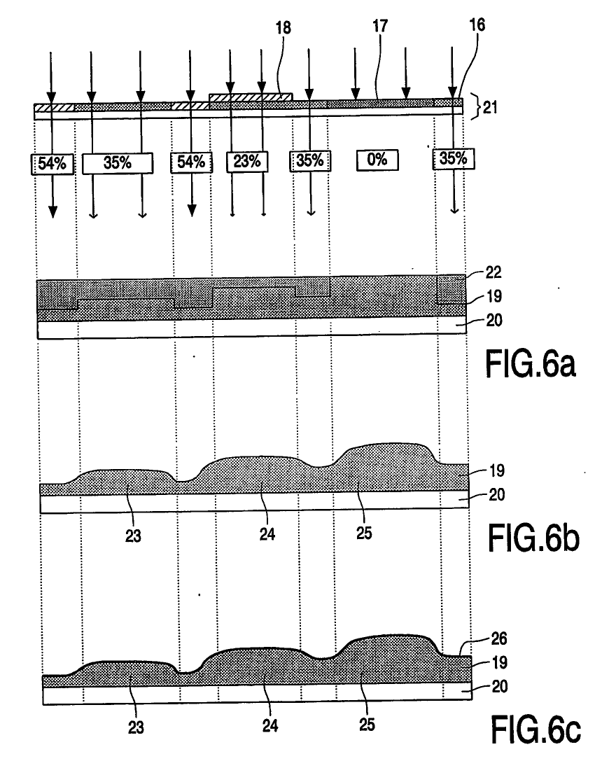

FIG. 6 depicts a method using a SiNx photo mask, for forming micro bumps on a TFT AMLCD pixel electrode, including a slanting feature; and

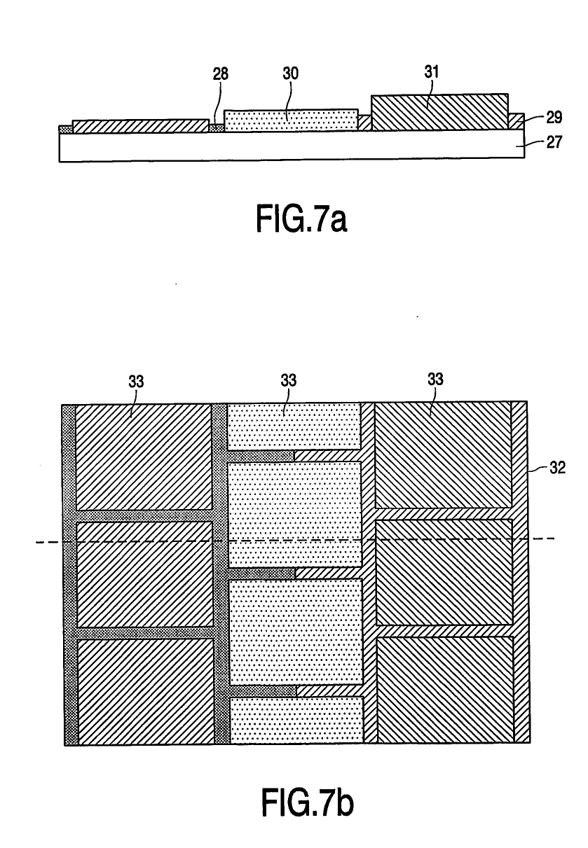

FIGS. 7a and 7b are a cross-sectional view and plan view respectively, of a TFT plate following the forming of the micro bumps having a slanting feature on its surface.

FIGS. 1a to 1e illustrate one embodiment of the method of production of diffusely reflective pixel electrodes for use in an AMLCD, using SiNx grey-tone masks. In this example, the AMLCD incorporates micro-bumps without the diffusive micro slant reflection (DMSR) feature.

FIG. 1a illustrates an active matrix liquid crystal display (AMLCD) device incorporating the diffusely reflective TFT electrode whose fabrication is shown in FIGS. 1b to 1e. A liquid crystal 1 is interposed between a TFT plate 2 and a glass substrate 3. Also shown is a colour filter layer 4 which may be arranged in a pattern of red, green and blue regions to provide an array of red, green and blue pixels. The TFT 5 is switched by row and column electrodes (not shown).

FIG. 1b is a cross sectional view of a TFT pixel electrode plate 2 as used in the AMLCD, after a layer of photo-definable polymer 6 has been applied. The polymer may consist of a material such as polyimide, acrylic, or photoresist. In one example, the material used was positive-tone aqueous developing photodefinable HD-8001 polyimide as produced by HD Microsystems. This may be applied using a known method, such as that of spinning or screen-printing. Also illustrated in FIG. 1b is the SiNx grey-tone mask 7 which is employed for the photolithographic stage in the production process. This mask is formed by the deposition of layers of semi-transparent SiNx 8 and opaque chrome 9 onto a UV-transparent mask substrate 10. A region 10A of the mask is not coated with the layers 8 or 9 and is thus transparent to UV light.

The mask 7 is placed in registration with the TFT plate, and UV light is directed through it in order to expose the photo-definable polyimide coating 6 on the TFT plate 2. FIG. 1 c depicts this stage in process, illustrating the TFT plate 2 following the UV-exposure, which results in exposed regions 11 of polysilicon. Areas of the polysilicon directly beneath chrome regions 9 of the mask will not be exposed, due to the opaque characteristics of chrome. These are marked 0% Tr on the figure, representing 0% transmission of UV. Areas of the photo-definable polyimide that are directly beneath UV-transparent regions of the mask such as region 10A, will be fully exposed and those areas beneath SiNx regions 8 will be partly exposed, for example as that marked 35% Tr, the exposure being dependant on the optical properties of the SiNx used. This photolithographic process is used to define the micro-bumps 12 and the via 13 for a connection to the TFT electrode 5. In positive photolithography, a certain thickness of the exposed photo-definable polyimide 6 will then be removed in a development stage, this thickness being dependent on the amount of UV-exposure.

FIG. 1d is a cross sectional illustration of the TFT plate following the development stage of the photo-definable polyimide 6. Exposed areas 11 of the polyimide have now been removed, and the surface topography of the polyimide now features the micro-bumps 12, and the via 13, for the pixel electrode 5 contact.

FIG. 1e illustrates the TFT plate following the final stages of its production. The plate is firstly heated to induce reflow which results in the rounding of the micro-bumps 12, giving them the required topography for a diffusely reflective pixel electrode. Secondly, a layer of highly reflective metal 14, such as aluminium or silver is applied to the surface of the TFT plate in a method such as sputtering.

The SiNx grey-tone mask may be formed by the plasma deposition of SiNₓ:H onto a UV-transparent substrate such as a quartz plate. In one example, RF capacatively coupled plasma deposition was carried out at 13.56 MHz, at a temperature in the range 200 to 350 degrees centigrade and a pressure in the range 50 to 200 pascals. Other frequencies, temperatures and pressures may also be used. The preferred deposition gases were a mixture of silane, ammonia, nitrogen and hydrogen, although other mixtures could be used. The fraction of nitrogen, x, in the particular layer being deposited can be varied from 0.001 to 1.4 which results in an increase in the optical band gap of the material from 1.7 eV to 6.0 eV. Preferably the fraction x used is between 0.2 and 0.6 with associated band gaps of between 2.1 eV and 2.5 eV. FIG. 2 is a graph illustrating the optical band gap Eopt exhibited by a layer of plasma deposited SiNx according to the ratio of NH₃ (ammonia gas) to SiH₄ (silane gas) used in the deposition process.

By incorporating SiNx of particular optical band gap in the grey-tone mask, a particular percentage of UV-light transmission will be observed. FIG. 3 is a graph illustrating the transmission percentage, according to the wavelength of the UV light, exhibited by three different layers of SiNx, A, B and C. The optical band gap of the SiNx of layer A is of 2.3 eV and that of layer B is 2.14 eV. The layer marked as C has the optical band gap of a combination of one layer of A and one layer of B. Typically, UV processing uses the g, h or i emission lines of mercury light, as shown on FIG. 3.

FIG. 4 is a graph representing the transmission properties of three layers of SiNx, D, E and F, each with an optical band gap of 2.3 eV, and deposited with increasing thickness. Layer D has a thickness of 60 nm, E of 66 nm, and F of 78 nm. Although slightly influencing the transmission property of the SiNx layer, the thickness has relatively little influence in comparison with the optical band gap, particularly for UV-light at the h-line wavelength. This is a property that contributes to the low cost of producing SiNx grey-tone masks, as great precision regarding deposition thickness is not vital.

FIG. 5 illustrates an example of the process of manufacture of a SiNx photo mask as may be used in the invention. In the first stage, plasma deposition on to a UV-transparent substrate 15 is used to form a first layer of a SiNx 16, having a thickness of 60nm, and an optical band gap of 2.14 eV. Using the h-line of UV-light, this layer would have a UV transmission of 35%, or alternatively 23% when used in combination with a SiNx layer of an optical band gap of 2.3 eV. Accordingly, the layer is then patterned using known techniques so as to leave only the regions where 35% or 23% transmission are required. FIG. 5a is a cross-sectional view of the mask after these first stages of its production.

In a further stage in the process of production of the mask, a layer of chrome 17 is deposited onto the substrate 15 and patterned. The chrome is left in regions of the mask where 0% UV-transmission is required. Additionally, the chrome is also left in regions where 35% transmission is required, i.e. over the previously deposited SiNx layer 16. This done so that the chrome layer 17, acts as a shielding layer to the first SiNx layer 16, when further SiNx layers are deposited. The resultant mask is illustrated in FIG. 5b.

FIG. 5c is a cross section of the mask following the deposition and patterning of second SiNx layer 18, having a thickness of 60 nm, and an optical band gap of 2.3 eV. This is left in regions of the mask where 23% or 54% transmission is required, 23% being achieved by this layer of SiNx 18 in combination with the first layer of SiNx 16.

FIG. 5d is a cross section of the mask following a second pattering of the chrome layer 17. This is done to expose the regions where 35% transmission is required, i.e. where the first layer 16 of SiNx was deposited. The mask is now completed, in this example having 5 different transmission properties, 0%, 23%, 35%, 54% and 100%, as shown in FIG. 5d.

FIGS. 6a to 6c illustrate a method incorporating a SiNx photo mask to produce a DMSR (diffusive micro slant reflector) pixel electrode for a TFT AMLCD. As has been previously described, the first stage involves the application of a layer of photo-definable material 19 to a pre-prepared TFT plate 20. In this example the layer 19 is HD Microsystems HD-8001 and is applied using the known technique of spin-coating at approximately 500 to 3000 rpm, to produce a polyimide thickness of approximately 2 μm. A photo mask 21 similar to that of FIG. 5 is then placed in registration with the TFT plate and UV light is directed through it to expose the photo-definable polyimide 19. This stage in the process is illustrated in FIG. 6a, where the exposed region 22 has a thickness dependant on the percentage of UV-light transmission through the photo mask 21. Layers on the photo mask are chrome 17, a first layer of SiNx with 35% transmission 16, and a second layer of SiNx with 54% transmission 18. As previously mentioned, a combination of the two different layers of SiNx provides a transmission of 23%. The features on the photo mask that define the micro-bumps of the DMSR pixel in this example are square when viewed from above, and are approximately 2 μm across. Each slanted region, such as that of FIG. 6a, has a length of approximately 5 μm in this example.

FIG. 6b is a cross-sectional view of the TFT plate following the development of the exposed polyimide, and a further process of heating to induce reflow. This results in the surface topography of the reflective pixel electrode having the rounded micro bumps, in addition to the slanted feature, which results in bumps 23, 24 and 25 being increasingly higher. In a final stage of this example, a layer of highly reflective aluminium 26, although silver could also be used, is applied to the TFT plate using the process of sputtering. The resultant DMSR pixel electrode is illustrated in FIG. 6c.

FIG. 7a depicts a cross-sectional view of the DMSR pixel electrode at a stage in its manufacture. The photolithographic exposure stage has been carried out, and development of the photo-definable polyimide has then occurred. In this example, the TFT plate 25 now has four different thicknesses of polyimide remaining, shown as 28, 29, 30 and 31. A plan view of the pixel electrode 32 is illustrated in FIG. 7b to give an indication of its layout. Each of the micro-bumps 33 are square in this example, although shapes such as other polygons or circles could also be used. There may also be many more micro-bumps 33 per pixel 32, in order that an acceptable viewing area of the LCD is provided.

From reading the present disclosure, other variations and modifications will be apparent to persons skilled in the art. Such variations and modifications may involve equivalent and other features which are already known in the design, manufacture and use of photo masks and which may be used instead of or in addition to features already described herein.

1. A method of forming shaped structures on a device plate comprising applying a photosensitive layer to said plate, and forming the shaped structures on the photosensitive layer in a photolithographic process using a grey-tone photo mask which comprises at least one region of semi-transparent material said material having a degree of transparency which is dependent on the optical band gap of the material.

2. A method according to claim I wherein the material regions used in the grey-tone photo mask are hydrogenated silicon-rich silicon nitride SiNx:H with x less than 1.

3. A method according to claim 1 wherein, prior to forming of the shaped structures in the liquid crystal display cells, the method further comprises the steps of forming the photo mask including:
depositing a layer of said semi-transparent material to form said region of semi-transparent material on a UV-transparent substrate;
patterning said semi-transparent material;
depositing a layer of UV-opaque material onto the substrate; and
patterning said layer of UV-opaque material.

4. A method according to claim 3, including:
depositing a layer of a second semHransparent material having a different degree of transparency to the first material, where the degree of transparency is dependent on the optical band gap of the material, to form a second region of semi-transparent material on said UVtransparent substrate; and
patterning said second semi-transparent material.

5. A method according to claim 4 including patterning once again said layer of UV-opaque material.

6. A method according to claim 3, wherein the UV-opaque material is Cr.

7. A method according to claim 1 wherein said photo mask is used in said photolithographic process so as to produce an irregular surface topography for a diffusely reflective pixel electrode of a liquid crystal display.

8. A method according to claim 7 wherein said surface topography for said diffusely reflective pixel electrode of the liquid crystal display has multiple levels of thickness.

9. A method according to claim 1 including forming an a AMLCD including the device plate.

10. A liquid crystal display device fabricated by a method as claimed in claim 1.

11. A mask configured for use in a method as claimed in claim 1.
